(19) United States
(12) Patent Application Publication
(10) Pub. No.: US 2008/0020160 A1
(43) Pub. Date: Jan. 24, 2008

(54) Polymeric pipes and containers with high barrier layers

(76) Inventors: Shailesh Ratilal Doshi, Kingston (CA); Robert B. Fish JR., Parkersburg, WV (US); Steven A. Mestemacher, Parkersburg, WV (US); Paul D. Seabrook, Amherstview (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/789,060

(22) Filed: Apr. 23, 2007

Related U.S. Application Data
(60) Provisional application No. 60/795,297, filed on Apr. 27, 2006.

(51) Int. Cl. C09J 5/06; B32B 1/08

(52) U.S. Cl. 428/35.7; 156/320

(57) ABSTRACT

Polymeric pipes with barrier layers are made by attaching to a pipe a multilayer structure which comprises a barrier layer and at least one irregularly surfaced sheet. The resulting pipes, which have reduced permeation to various substances, are useful for reducing loss of materials which are valuable, toxic and/or environmentally harmful.

### FIELD OF THE INVENTION

Polymeric pipes with barrier layers are produced by wrapping or otherwise covering the outside of the pipe with a multilayer structure comprising at least one polymeric barrier layer and a irregularly surfaced sheet to which the barrier layer is melt bonded.

### TECHNICAL BACKGROUND

Pipes and various containers are used to transport and/or store many different types of gases and liquids. In many instances these substances are valuable, and/or flammable and/or toxic, and it is thus desirable to prevent loss of these substances by diffusion through the pipe or container. For example if a pipe or container is underground and the material therein is toxic, loss of the material may contaminate the ground and/or groundwater, leading to environmental contamination.

When these pipes and containers are metal this is not usually a problem. However if the pipe or container is plastic, many substances have significant diffusion rates through the plastic. Plastic pipes are often preferred over metal pipes because they do not corrode as readily, are lighter and/or easier to install. However the diffusion problem often precludes the use of plastic pipes.

It is known that certain plastics, especially certain thermoplastics, have lower permeabilities to certain fluids and/or gases than most plastics, and these have been used as barrier layers, for example in plastic bottles, food packaging and pipes. Sometimes it is possible to make a multilayer extrusion to incorporate the barrier layer into these types of structures to reduce diffusion through them. However sometimes multilayer extrusion is not possible or is too expensive because typically different types of plastics do not adhere to each other, extrusion of the barrier layer is very difficult, or other reasons. Simple wrapping of the pipe or container with the barrier layer itself is often not feasible because barrier polymers tend to be expensive and therefore thin, but often fragile, layers are preferred. Such barrier polymers also usually do not adhere well to the pipe so the barrier layer has “defects”. Thus alternative ways of making barriers layers for pipes and containers are desired.

US Patent Application Publication 20050003721 describes a method of bonding different thermoplastics to each other by melt bonding the two thermoplastics to (or through) a resin sheet having an irregular surface.

### SUMMARY OF THE INVENTION

This invention concerns a process for the application of a barrier layer to a pipe or container, comprising, attaching to an outer surface of said pipe or container a multilayer structure comprising at least one barrier layer resin melt bonded to at least one resin sheet having irregular surfaces.

Also claimed herein is the product of the above process.

### DETAILS OF THE INVENTION

Herein certain terms are used, and some of them are defined below.

“Sheet” means a material shape in which two of the surfaces have at least about twice, more preferably at least about 10 times, the surface areas of any of the other exterior surfaces. Included in this definition would be a sheet with the dimensions 15 cm×15 cm×0.3 cm thick, and a film 15 cm×15 cm×0.2 mm thick. The latter (which is often called a film) in many instances will be flexible and may be drapeable, so that is can be adapted to conform to irregular surfaces. Preferably the sheet has a minimum thickness of about 0.03 mm, more preferably about 0.08 mm, and especially preferably about 0.13 mm. Preferably the sheet has a maximum thickness of about 0.64 mm, more preferably about 0.38 mm, and especially preferably about 0.25 mm. It is to be understood that any preferred minimum thickness can be combined with any preferred maximum thickness to form a preferred thickness range.

“Irregular surface” means that the surface has irregularities in or on it that will aid in mechanically locking to it any molten material which flows into or onto the surface and the irregularities thereon, and when the molten material subsequently solidifies it causes the material to be mechanically locked (i.e. bonded) to the irregular surface.

“Resin” means any polymeric material, whether of natural or manmade (synthetic) origin. Synthetic materials are preferred.

“Irregular surface sheet (ISS)” means a sheet having an “irregular surface”, usually on both sides of the sheet.

“Melt bonding” means the TP is melted where “melted” means that a crystalline TP is heated to about or above its highest melting point, while an amorphous thermoplastic is melted above its highest glass transition temperature. While melted the TP is placed in contact with an appropriate surface of the ISS. During this contact, usually some pressure (i.e. force) will be applied to cause the TP to flow onto and perhaps penetrate some of the pores or irregularities on the surface of the ISS. The TP is then allowed to cool, or otherwise become solid.

“Thermoplastic” (TP) is material that is meltable before and while being melt bonded to the ISS, but in their final form are solids, that is they are crystalline or glassy (and therefore typical elastomers, whose melting points and/or glass transition temperature, if any, are below ambient temperature, are not included in TPs, but thermoplastic elastomers are included in TPs). Thus this can mean a typical (i.e. “classical”) TP polymer such as polyethylene. It can also mean a thermosetting polymer before it thermosets (e.g. crosslinks), that is, while it can be melted and flows in the molten state. Thermosetting may take place after the melt bonding has taken place, perhaps in the same apparatus where the melt bonding took place, and perhaps by simply further heating of the thermoset resin, to form a resin which is glassy and/or crystalline. Useful thermoplastic elastomers include block copolyesters with polyether soft segments, styrene-butadiene block copolymers, and thermoplastic polyurethanes.

By TPs being “different” is meant that they have a different chemical composition. Examples of different thermoplastics include: polyethylene (PE) and polypropylene; polystyrene and poly(ethylene terephthalate) (PET); nylon-6,6 and poly(1,4-butylene terephthalate; nylon-6,6 and nylon-6; polyoxymethylene and poly(phenylene sulfide); poly(ethylene terephthalate) and poly(butylene terephthalate); poly(ether-ether-ketone) and poly(hexafluoropropylene)(perfluoromethyl vinyl ether) copolymer); a thermotropic liquid crystalline polyester and a thermosetting epoxy resin (before crosslinking); and a thermosetting melamine resin (before crosslinking) and a thermosetting phenolic resin (before crosslinking). Different thermoplastics may also include blends of the same thermoplastics but in different proportions, for example a blend of 85 weight percent PET and 15 weight percent PE is different than a blend of 35 weight percent PET and 65 weight percent PE. Also, different includes differing the presence and/or amount of other comonomers, for example PET is different than poly(ethylene isophthalate/terephthalate).

“Bonded” herein is meant the materials attached to one another, in most instances herein permanently, and/or with the ISS between the materials. Typically no other adhesives or similar materials are used in the bonding process, other than the ISS.

The ISS sheet may have irregular surfaces formed in many ways. It may be: a fabric, for instance woven, knitted or nonwoven; a paper; foamed, particularly an open cell foam and/or a microcellular foam; a sheet with a roughened surface formed by for example sandblasting or with an abrasive such as sandpaper or sharkskin; and a microporous sheet (MPS). Preferred forms of ISS are fabrics, especially nonwoven fabrics (NWFs), and microporous sheets (MPSs).

“Microporous” means a material, usually a thermoset or thermoplastic polymeric material, preferably a thermoplastic, which is at least about 20 percent by volume, more preferably at least about 35% by volume pores. Often the percentage by volume is higher, for instance about 60% to about 75% by volume pores. The porosity is determined according to the equation:
“Porosity”=100(1−d₁/d₂)

wherein d₁ is the actual density of the porous sample determined by weighing a sample and dividing that weight by the volume of the sample, which is determined from the sample's dimensions. The value d₂ is the “theoretical” density of the sample assuming no voids or pores are present in the sample, and it determined by known calculations employing the amounts and corresponding densities of the samples ingredients. More details on the calculation of the porosity may be found in U.S. Pat. No. 4,892,779, which is hereby incorporated by reference. Preferably the microporous material has interconnecting pores.

The MPS herein may be made by methods described in U.S. Pat. Nos. 3,351,495, 4,698,372, 4,867,881, 4,874,568, and 5,130,342, all of which are hereby included by reference. A preferred microporous sheet is described in U.S. Pat. No. 4,892,779, which is hereby included by reference. Similar to many microporous sheets those of this patent have a high amount of a particulate material (filler). This particular type of sheet is made from polyethylene, much of which is a linear ultrahigh molecular weight polymer.

“Fabric” is a sheet-like material made from fibers. The materials from which the fibers are made may be synthetic (man-made) or natural. The fabric may be a woven fabric, knitted fabric or a nonwoven fabric, and nonwoven fabrics are preferred. Useful materials for the fabrics include cotton, jute, cellulosics, wool, glass fiber, carbon fiber, poly(ethylene terephthalate), polyamides such as nylon-6, nylon-6,6, and aromatic-aliphatic copolyamides, aramids such as poly(p-phenylene terephthalamide), polypropylene, polyethylene, thermotropic liquid crystalline polymer, fluoropolymers and poly(phenylene sulfide).

The fabric herein can be made by any known fabric making technique, such as weaving or knitting. However a preferred fabric type is a NWF. NWFs can be made by methods described in 1. Butler, The Nonwoven Fabrics Handbook, Association of the Nonwoven Fabrics Industry, Cary, N.C., 1999, which is hereby included by reference. Useful types of processes for making NWFs for this invention include spunbonded, and melt blown. Typically the fibers in the NWF will be fixed in some relationship to each other. When the NWF is laid down as a molten TP (for example spunbonded) the fibers may not solidify completely before a new fiber layer contacts the previous fiber layer thereby resulting in partial fusing together of the fibers. The fabric may be needled or spunlaced to entangle and fix the fibers, or the fibers may be thermally bonded together.

The characteristics of the fabric to some extent determines the characteristics of the bond(s) between the TPs to be joined. Preferably the fabric is not so tightly woven that melted TP has difficulty (under the melt bonding condition used) penetrating and/or flowing into and/or around the fibers of the fabric. Therefore it may be preferable that the fabric be relatively porous. However, if the fabric is too porous it may form bonds which are too weak. The strength (including interlayer strength) and stiffness of the fabric (and in turn the fibers used in the fabric) may determine to some extent the strength and other properties of the bond(s) formed. Higher strength fibers such as carbon fiber or aramid fibers therefore may be advantageous in some instances. Also the use of vacuum to remove trapped gas (air) bubbles may also be useful in forming the multilayer sheet.

By a “barrier layer” is meant a layer comprising a resin, preferably a classical thermoplastic, that has relatively low permeability to one or more liquids and/or gases of which it is desired to reduce permeation through a pipe and/or container.

By “attaching” or “attachment” of one item to another is meant that the two items when attached or at the end of the attaching are together in a single assembly that is not readily separable by normal handling or use. For instance for a pipe covered with a sheet material containing a barrier layer the sheet material will not normally move or be readily removable from the main body (wall) of the pipe.

Attaching a barrier layer containing sheet material (BLSM) to a pipe or can be accomplished in a variety of ways. Although the following discussion deals with pipes, containers of various cross sections, especially cylindrical containers can also be attached to BLSM in a similar fashion.

A simple way of doing this is to take a sheet of BLSM which has one layer of barrier resin and one layer of irregularly surfaced sheet which is melt bonded to the barrier resin and wrap it around the pipe and secure it mechanically. This may be done by simply wrapping a sheet of BLSM whose width is the same as the length of the pipe (section) and securing it. Or a strip of the BLSM may be wrapped in a helical fashion around the pipe, starting at one end and proceeding to the other (or a “continuous” pipe section may be wrapped continuously). The latter may be accomplished by the use of so-called pipe wrapping machines, which are well known in the art, see for instance German Patent 4,329,676, Japanese Patent Application 05230204 and U.S. Pat. No. 5,079,307. Alternatively the pipe may be helically wrapped in a continuous fashion as it exits an extruder die in which it is formed and preferably the exterior surface is still hot enough to melt bond to the BLSM, or already formed lengths of pipe may be fed into a helical wrapper and optionally surface heated beforehand so that the BLSM melt bonds to the surface of the pipe. In either instance the BLSM is wrapped around the pipe such that the irregularly surfaced sheet is in contact with the outer surface of the pipe. If not already melt bonded the assembly may then be heated (especially on the “outer surface”) to melt bond the irregularly surface sheet to the exterior surface of the pipe. For a detailed description of melt bonding methods in general see US Patent Application Publication 20050003721, which is hereby included by reference. As may be evident to the artisan, in one preferred form the melting or softening temperature of the pipe be lower than the melting or softening temperature of the barrier layer resin.

In another preferred form the pipe may be higher melting (than the barrier layer to be used) and an ISS first bonded to the pipe exterior surface, then the barrier layer melt bonded to the ISS and perhaps another outer ISS also (this is included within the meaning of the BLSM since it results in such a multilayer structure being attached to the pipe). Or a multilayer structure comprising at least one ISS and a higher melting barrier layer may be melt bonded to a lower melting pipe material by bonding to the ISS.

The above procedure will result in an assembly in which the pipe is interior to the BLSM, and the outer surface of the assembly is the barrier layer. This barrier layer is often fragile and/or thin and it sometimes would be preferable to protect this barrier layer. If this is desired the BLSM may have 4 layers, they being ISS/BL/ISS/PL, wherein ISS is irregularly surfaced sheet, BL is barrier layer, and PL is a protective resin layer. The PL may be any TP which is suitable to protect the outer surface. Before application to the surface of the pipe these 4 layers are preferably melt bonded to each other in the order shown. The ISS allows two different TPs to be bonded to each other, and the PL may be any TP with the desired physical properties.

The BLSM with various layers may be made by melt bonding the appropriate layers to each other in the order desired. Such processes are described in previously incorporated US Patent Application Publication 20050003721.

In another variation the BLSM may have layers in the order TP1/ISS/BL/ISS/PL wherein TP1 is the same TP from which the outer surface of the pipe is made. Here melt bonding may be accomplished because the TP1 of the BLSM will melt bond to the pipe outer surface because it is the same material.

In order to accomplish melt bonding it is sometimes desirable to apply some pressure to the bond that is forming. This may be accomplished by using heat activated shrink wrap applied over the BLSM. This may be applied as describes for the BLSM above. After the shrink wrap is applied the assembly is heated to cause the shrink wrap to shrink and also to accomplish the melt bonding. It is preferred the polymer melting or softening to form the melt bond do so at or at a slightly lower temperature than the shrinkage temperature of the shrink wrap. The shrink wrap, after the melt bonding step, may also serve as an outer protective layer for the BLSM.

Other variations of these melt bonding techniques will be evident to the artisan. It is also possible to use pipe that has no melting point, that is the TP is amorphous (glassy). In that instance if the BLSM is melt bonded to the pipe the exterior surface of the pipe may be analogously (to a semicrystalline TP) heated above glass transition temperature of the glassy polymer in order to carry out the melt bonding.

Alternatively the BLSM may be attached by mechanical means. For instance the plastic pipe surface may be roughened by some mechanical means, for example just after leaving an extruder or later on. Such roughening for instance could be similar to applying a knurled pattern. The BLSM may then be tightly wrapped around the roughened out surface of the pipe with an ISS directly contacting the outer pipe surface, and then the BLSM overwrapped with heat shrink film. The assembly is heated enough to shrink the film but not melt bond the pipe surface to the ISS. The “pressure” applied by the heat shrink film may mechanically hold the BLSM in place by mechanically locking the exterior of the pipe to an ISS layer of the BLSM. If the outer surface of the BLSM is also an ISS, it will also help hold the shrink wrap in place. Other similar mechanical attachment techniques will be evident to the artisan.

In order for the barrier layer to function efficiently most or all of the surface of a container or pipe, especially a container should be covered where possible. In some instances it may be desirable to cover part of the length of a pipe with a BLSM, and such a covering not be needed on another length of the pipe. Preferably at least 80% of the surface area of a pipe or container, more preferably a container, more preferably at least 90%, and especially preferably at least 98%, of a pipe or container be covered by the BLSM.

When wrapped around the pipe or container the structure of the BLSM, aside from the number of layers and their composition, and the nature and size of the overlap (if any) between helical or other type windings over the surface of the pipe or container may affect the efficiency of the barrier layer, i.e., how well the barrier layer restricts the overall flow of various substances through the layer. The overlap between adjacent windings may provide a path for increased loss of materials by permeation through the pipe and BLSM. One way to avoid this, for instance, is to have a BLSM, say in strip form to be helically wound, which contains 1 layer of irregularly surfaced sheet and 1 barrier layer (other optionally overlapping layers may also be attached exterior to the barrier layer). One edge (lengthwise) the barrier layer is slightly wider than the irregularly surfaced sheet layer. When the BLSM strip is helically wound around the pipe, with the irregularly surfaced strip contacting the exterior of the pipe, the edge with the wider barrier layer overlaps the previous layer so that the barrier layer of the new winding is on top of the barrier layer of the previous winding. As described above if desired the whole assembly may be melt bonded together, and optionally a separate protective layer(s) and/or shrink wrap may also be overwrapped over the BLSM.

This “sealing” of the adjacent (usually) helically wound layers may be effectively accomplished by methods known in the art. For instance a sealant such as a thermoset resin (for example an epoxy resin) or thermosetting elastomeric sealant may be used, or multiple overlapping layers may be used. Or the pipe may be wrapped helically in one direction and then helically in the other direction, with or without additional sealing and/or sealant.

The barrier layer may be an synthetic resin that has the desired barrier properties for the materials in the pipe or container that one wishes to keep from permeating through. Useful types of polymers include thermotropic liquid crystalline polymers (LCPs), fluoropolymers, and crystalline thermoplastics with good permeation resistance to the potential permeant(s) under consideration, such as polyamides, polyesters and acetals. Typically thin layers of these polymers may be extruded and laminated to irregularly surfaced sheets as described above. Typically a barrier layer will (before melt bonding) be about 1 to about 300 μm, more typically about 10 to about 200 μm thick. It is of course important that the barrier layer be continuous, i.e., does not have an (pin)holes or cracks in it so that material may not escape through these defects.

A preferred type of barrier layer is an LCP. A material is an LCP if it passes the TOT test or any reasonable variation thereof, as described in U.S. Pat. No. 4,118,372, which is hereby included by reference. Commonly LCPs are aromatic polyesters and aromatic poly(ester-amides), and these are preferred types of LCPs. By aromatic is meant the linking ester and (where applicable) amide groups are directly attached to aromatic rings. Another preferred type of polyester or poly(ester-amide) LCP is partially aromatic, that is some of the linking groups are attached to aromatic rings either on one end or both ends of the linking, and some are not attached to aromatic rings. Preferred LCPs may also comprise repeat units derived from one or more of the following: 4-hydroxybenzoic acid, 3-hydroxybenzoic acid, 6-hydroxy-2-napthoic acid, terephthalic acid, isophthalic acid, 4,4′-biphenyldicarboxylic acid, hydroquinone, 4,4′-biphenol, 2,6-dihydroxynaphthalene, 2-methylhhydroquinone, ethylene glycol, resorcinol, bisphenol-A, 2-t-butylhydroquinone, 1,4-diaminebenzene, and 1,3-diaminobenzene.

LCPs are preferred types of barrier layers because they often have very good barrier properties to most substances, are often high melting so they can be used at elevated temperatures, and are relatively chemcially resistant to most permeants. However making thin LCP films that do not crack readily when unsupported is often difficult because of the anisotropy of this type of polymer. Films often tend to crack or develop other defects. “Supporting” the LCP film by melt bonding it to an irregularly surfaced sheet (and optionally other layers) often reduces this tendency to crack. Since LCPs are particularly difficult to adhere to other resins, the use of the irregularly surfaced sheet is especially advantageous, since this method work well to adhere LCPs to other resins.

Such BLSM wrapped pipes and containers are useful in a variety of applications. For instance the leakage of fuels such as gasoline or diesel fuel into the air and/or ground is a serious environmental problem, resulting in smog in the air and groundwater contamination. This leakage into the air may occur from resin fuel tanks and/or fuel lines, while leakage into the ground may occur because of permeation of fuel (components) through resin pipes and or containers (storage tanks). In another situation natural gas may be contaminated with H₂S and it may be desirable to retard diffusion of the H₂S into the ground. Covering such pipes and containers with barrier layers as described herein will help reduce the environmental contamination associated with these items. Other similar situations can be envisioned for handling other types of materials, such as chemicals of various kinds, crude oil, lubricants, and sewage and other waste streams.

In another type of use, it may be desirable to prevent permeation of contaminants into the contents of the pipe. For example potable water may be so protected so as to ensure the water's purity. In hot water system the ingress of oxygen may be blocked so as to slow down the corrosion of metal parts in the water system.

Pine Permeation Test

Permeation from a pipe was measured using a specially developed apparatus. The apparatus consisted of two opposing metal flanges between which the plastic pipe specimen was positioned. The flanges each had indentation in the face engaging with the pipe end to accommodate a leak-proofing gasket against the pipe end. The gasket material was Viton® fluoroelastomer. The assembly was held together by a set of four tie rods. One of the flanges had a closeable aperture that was used to introduce a fluid of interest into the pipe. After filling the pipe to about 90% of its volume and ensuring that the assembly was leakproof, it was maintained in a controlled environment at a temperature of 23° C. and 50% relative humidity. The weight of the assembly was monitored over time. A steady state rate of weight loss was reached after an initial saturation and breakthrough period due to permeation of the fluid through the pipe wall. This rate was used to determine the permeation rate.

Polymers Used

LCP A had the composition ethylene glycol/4,4′-biphenol/terephthalic acid/4-hydroxybenzoic acid/6-hydroxy-2-napthoic acid, 30/2/30/50/20 and has a normal melting point of about 200° C. It was made by mixing poly(ethylene terephthalate) with the other monomers and enough acetic anhydride to acetylate all of the hydroxyl groups of the monomers. LCP A has good barrier properties to a variety of substances. It was extruded into a film 0.09 mm thick, which was used in the Examples.

MIST® SP70 film, available from PPG Corp., Pittsburgh, Pa., U.S.A., was used as the irregularly surfaced sheet. This is a 0.18 mm thick microporous film believed to be made from ultrahigh molecular weight polyethylene filled with silica. Even though polyethylene melts when heated to temperatures of above about 135° C., due to the high molecular weight of the polymer and high level of filler loading, it does not exhibit significant flow or deformation at higher temperatures.

### EXAMPLE 1

A laminate was formed by bringing the LCP A film and the MIST® SP70 (a microporous sheet 0.18 mm thick available from PPG Corp., Pittsburgh, Pa., USA) film (both about 10 cm wide) into contact with each other, and pressing under a hot iron (made for ironing clothes) set at a face temperature of 254° C. The layers were pressed using pressure exerted by hand by moving the hot iron over them covering roughly 50 cm of length per minute so that the dwell time of the iron on any particular spot was about 45 sec, and then allowed to cool to ambient temperature to form a continuous tape. This was done with a layer of Teflon® polytetrafluoroethylene film between the iron and the two layers to be bonded so as to prevent sticking. Either the LCP film or the MIST film could be in contact with the Teflon® film. It was found that the LCP A layer was well bonded to the MIST® SP70 layer, forming a BLSM.

Barrier properties of the BLSM were measured by the gravimetric technique using the Thwing-Albert cup method as depicted in FIG. 5, as generally described in ASTM Method E96-66. This device consisted of a cup having a removable cover ring. The cup was filled with the permeant liquid, and the BLSM sample was clamped over the open top of the cup by the ring using an O-ring made of Viton® fluoroelastomer (available from E. I. DuPont de Nemours & Co., Inc, Wilmington, Del. 19898, USA) to provide a leakproof seal of the laminate over the cup top. The assembly was kept under controlled environment of temperature and humidity of 23° C. and 50% relative humidity. The assembly was weighed periodically to monitor the loss due to permeation through the laminate. Over the period of time, weight loss data was translated into permeation rate through the lamination.

A fluid mixture representing CM15 fuel and consisting of 42.5 vol. % isooctane, 42.5 vol. % toluene and 15 vol. % methanol was used as the permeant. The cup was filled with the fluid, and the BLSM was sealed over its opening. The cup was maintained in a circulating air environment for 100 days or more, and the loss in its weight was monitored.

Tests were conducted in two modes—in the first case the MIST® SP70 side of the BLSM was facing the inside of the cup and hence the contained fluid. In the second case, LCP A layer was facing the fluid. The total weight loss over the measured period, and associated daily average rate of loss over that time are shown in Table 1.

TABLE 1

| | Test Period | Average Daily Rate of |
|---|---|---|
| Test Mode | (days) | Weight Loss (g/m²/day) |
| MIST ® side facing the fluid | 48 | 107.4 |
| LCP Facing Fluid | 136 | 0.002 |

While identical laminates were used in both modes, when the irregularly surfaced layer was facing the fluid, the rate of permeation loss was almost 2 orders of magnitude higher. This is believed to be due to the loss through the edge of the BLSM where MIST® was exposed to the environment. When barrier LCP layer was facing the fluid, there may have been a better seal to the actual barrier layer. The results of the example illustrate the possible desirability for ensuring that when BLSM is attached to the pipe, the exposed edge of the irregularly surfaced layer should be either eliminated or minimized as much as possible to realize the maximum benefit of the barrier layer.

### EXAMPLE 2

A high density polyethylene pipe with outside diameter of 32 mm and wall thickness of 3 mm was used in this example. A BLSM tape 65 mm wide (overall width of the LCP layer) was formed as described in Example 1. The tape was formed such that along one edge (herein the first edge), the width of the MIST® film was narrower than that of the LCP film by about 12.5 mm. During wrapping over a pipe, this construction provided an LCP to LCP overlap.

The tape was tightly hand wrapped around a 20 cm (8″) length of the pipe in a helical manner such that the direction of wrapping was roughly at 60 degrees to the pipe axis. Wrapping was done such that the first edge of the tape was overlapped over the previous turn of the wrap by about 12.5 mm thus forming a barrier layer to barrier layer overlap with no exposed edge of the MIST®. The wrapping was held tightly in place by a piece of high temperature adhesive tape applied at either end of the BLSM.

The assembly was subjected to heat in a circulating air oven to soften the outside surface of the pipe and bond it to the adjacent MIST® layer. By simply experimenting with temperature and duration of heating, it was determined that conditions of 170° C. for 13 minutes provided good bubble-free melt bonding. Upon withdrawal, the test pipe was allowed to cool.

Barrier properties of the pipe were determined as described above (the pipe samples were 100 mm long), using test fluid CM15 as described in Example 1. Comparative measurements were carried out using a sample of the high density polyethylene pipe without the BLSM. Details of the sample dimensions and results of permeation measurements are presented in Table 2.

TABLE 2

| | Dimensions | Test | Permeation | Average rate |
|---|---|---|---|---|
| Pipe | (dia. ×wall | Period | loss over test | of loss* |
| Sample | thick. × length mm) | (days) | period (g) | (gm/m²/day) |
| Unwrapped | 59.6 × 4.14 × | 134 | 6.36 | 3.64 |
| Pipe | 109.6 | | | |
| Example 2 | 31.6 × 3.94 × | 79 | 0.45 | 0.87 |
| | 107.0 | | | |

*based on the outside surface area of the pipe.

It was also noted that over the duration of the test period, the BLSM did not show any sign of detachment from the pipe surface.

### EXAMPLE 3

Test samples were prepared by thermally bonding two pieces of the laminates two pieces of the laminate of Example 1 such that they formed an overlap through and parallel to a diameter of the circular test sample. The overlap was set to be either 6.25 mm wide or 12.5 mm wide. In the overlap region, the test sample consisted of four layers, viz. LCP/MIST®/LCP/MIST®.

Permeation rates of the samples were measured by the gravimetric technique using the Thwing-Albert cup method described in Example 1 using the same CM15 test fuel mixture. Two samples with two different overlap widths were tested with the MIST® side facing the fluid, and one sample was tested with the LCP side facing the fluid. The average rates of permeation were determined as described in Example 1 by linear regression of the weights measurements Vs days of exposure. The results are shown in Table 3.

TABLE 3

| | Test Period | Average Daily Rate of |
|---|---|---|
| Test Mode | (days) | Weight Loss (g/m²/day) |
| 6.3 mm Overlap | 48 | 128 |
| MIST ® side facing the fluid | | |
| 12.5 mm Overlap | 48 | 118 |
| MIST ® side facing the fluid | | |
| 12.5 mm Overlap | 14 | 51.8 |
| LCP side facing the fluid | | |

The results show that when MIST side is facing the fluid, the rate of permeation loss is somewhat higher as compared to the test in Example 1 where there is no overlap. This is believed to be due to additional exposed edge of the MIST® along the overlap length. When LCP side is facing the fluid with the sample with the overlap, the rate of permeation is somewhat reduced as the length of the exposed edge is reduced. Nevertheless, the rates of permeation is still quite high compared to those in Example 1 where LCP is facing the fluid with no overlap. The above results clearly demonstrate the desirability of sealing the exposed edge of the ISS substrate if full potential of the barrier layer is to be realized.

### EXAMPLE 4

In this example various ways of sealing the exposed overlap edge were tested. Test samples were prepared to provide 12.5 mm overlap as described in Example 3. In some cases, the overlap region consisted of LCP®/MIST/LCP/MIST® as in Example 3. In other cases, test samples were prepared using tape made with a narrower MIST® film than the LCP film such that the LCP film extended over the MIST® film by 12.5 mm along one edge of the tape. Various sealing techniques were tried including use of an adhesive, thermal bonding, and the use of an additional LCP sealant layer as described in Table 4.

Permeation rates of the samples were measured by the gravimetric technique using the Thwing-Albert cup method described in Example 1 using the same CM15 test fuel mixture. All of the samples were tested with the LCP side facing the fluid. The average rates of permeation were determined as described in Example 1 by linear regression of the weights measurements versus days of exposure. Results are given in Table 4.

TABLE 4

| | Sample | | | Test Period, | Average daily Rate of | |
|---|---|---|---|---|---|---|
| # | Description | Sealing Technique | Overlap Structure | Days | Weight Loss (g/m²/day) | Comments |
| 1 | LCP-MIST- | A 2-part liquid epoxy applied | LCP/MIST/LCP/MIST | 6 | 114.5 | Stopped due to high rate |
| | epoxy | over the over the overlap region | epoxy on MIST side | | | of loss. |
| | | on MIST side and cured | | | | |
| 2 | LCP-epoxy- | A 2 part liquid epoxy applied | LCP/MIST/epoxy/LCP/ | 14 | 406.7 | Overlap seal failed after |
| | MIST | between the two layers of | MIST | | | 3 days. |
| | | laminates and cured | | | | |
| 3 | LCP-LCP | Tapes with wider LCP film | LCP/LCP | 14 | −0.31 | Not measurable. |
| | | used to provide LCP-to-LCP | | | | |
| | | overlap that is thermally | | | | |
| | | bonded at 195° C. | | | | |
| 4 | LCP-LCP | As above with a bead of 2- | LCP/LCP/epoxy | 14 | −0.16 | Not measurable. |
| | with a bead | part liquid epoxy applied over | | | | |
| | of epoxy | the overlap on the LCP side | | | | |
| | | and cured. | | | | |
| 5 | LCP-epoxy- | Tapes with wider LCP film | LCP/epoxy/LCP | 6 | 37.8 | Leakage at overlap after |
| | LCP | used to provide LCP-to-LCP | | | | 3 days. |
| | | overlap, and 2 part liquid epoxy | | | | |
| | | used between LCP layers | | | | |
| | | to bond | | | | |
| 6 | LCP-MIST | Overlap region covered with | LCP film/LCP/MIST/LCP/ | 14 | −0.51 | Not measurable. |
| | with LCP | an additional 50 mm wide | MIST | | | |
| | over-layer | LCP film on the LCP side and | | | | |
| | | thermally bonded at 195 C. | | | | |
| 7 | LCP-LCP | Tapes with wider LCP layer | LCP film/LCP/LCP | 14 | −0.21 | Not measurable. |
| | with LCP | used t provide LCP-to-LCP | | | | |
| | over-layer | overlap, covered with an additional | | | | |
| | | 50 mm wide LCP film | | | | |
| | | on the LCP side, and thermally | | | | |
| | | bonded at 195 C. | | | | |

In Table 4 negative rate numbers should not be interpreted as weight gain, but rather they indicate inherent experimental variability encountered in making these precise weight measurements when changes in successive measurements are very small due to very low rates of permeation.

It appeared that the epoxy used for sealing was attacked by the CM15 fuel, and as a result the seals failed. In cases where the sealant is resistant to the contained fluid, this is not likely to occur, and such a sealing technique may be useful.

### EXAMPLE 5

The BLSMs used in examples 1 to 4 were prepared by laminating a LCP film to MIST® SP70 manually using an iron. A continuous process was tested.

Lamination was done on a 60 cm (24″) wide Glenro thermal flat bed laminator (Glenro, Inc., Paterson, N.J. 07501, USA). It consisted of upper and lower driven flat belts with non-stick surfaces. The films to be laminated were fed into the nip of the belt and were laminated under heat and pressure in a continuous manner. The laminate was then passed through the nip of a pressure roll, and subsequently cooled for collection.

Laminate samples (10 cm, 4″ wide) were prepared using two types of ISS—

MIST® SP700, and a Artisyn® UAR 100 0.25 mm (10 mils) thick synthetic paper available from Artisyn Synthetic Paper Company, Owensboro, Ky. 42303, USA. Both are described to be highly filled polyolefins with large volumetric proportion of voids. A 0.08 mm (3 mils) thick LCP A film was used. Lamination conditions were:

Line speed of 1 meter/min, and since the line was 3.05 m long, dwell time was about 3 min.

Preheat temp. of 190° C.

Pressure roll temp. of 200° C.

Nip pressure of 207 kPa

Cooling section temp. of 40° C.

Both the types of material combinations were laminated successfully with strong bond between layers in continuous lengths.

Lamination was also carried out using a non-woven substrate as the ISS. The substrate used was a three-layer sheet. The two outer layers were made from spunbonded 20 μm diameter core-sheath filaments with a linear low density polyethylene (LLDPE) sheath and poly(ethylene terephthalate) (PET) core. The middle layer was made from side-by-side melt blown 2.5 μm diameter LLDPE and PET filaments. The 3-layer structure was point bonded into a 61 gm/m²(1.8 oz/yard²) fabric. A roughly 10 cm wide×30 cm long piece of this substrate was laminated to 0.08 mm thick LCP A film using a clothes iron set with sole plate set at 254° C. Using a dwell time of about 45 second per covered area, it was estimated that the sheets reached a temperature of around 195° C. Upon cooling, there was good adhesion between the layers. When attempting to pull apart with sufficient force, the individual layers of the non-woven laminate tended to come apart indicating that the bond to the LCP layer was stronger.

### EXAMPLE 6

A BLSM wrapped high density polyethylene pipe was made in the manner as described in Example 2, except the irregularly surfaced sheet was not MIST® SP70, it was the three layer nonwoven fabric described in Example 5. A good bond was obtained between the BLSM laminate and the HDPE pipe. When attempting to pull the laminate away from the pipe surface, failure generally occurred within the surface layer of the non-woven ISS where fibers tended to be pulled apart.

### EXAMPLE 7

A BLSM wrapped high density polyethylene pipe was also made in the manner as described in Example 2, except the irregularly surfaced sheet was not MIST® SP70, it was the Artisyn UAR 100 0.25 mm (10 mil) thick synthetic paper described above. The pipe used was nominally 82 mm (3.25″ OD)×6.25 mm (0.25″) thick wall black HDPE pipe. The BLSM laminate used was 15 cm (6″) wide. The laminate was wrapped manually over an approximately 30 cm (12″) long piece of pipe at an angle of about 60 degrees to the pipe axis so as to provide 12.5 mm overlap between adjacent layers. The wrapping was held tightly in place by using pieces of high temperature adhesive tape at the ends. The wrapped pipe was exposed to an environment of circulating air at 170° C. for a period of 15 minutes in a vertically suspended position in an oven to effect bonding. Upon withdrawal, the pipe was allowed to cool. The laminate had developed a strong bond to the exterior pipe surface.

What is claimed is:

1. A process for the application of a barrier layer to a pipe or container, comprising, attaching to an outer surface of said pipe or container a multilayer structure comprising at least one barrier layer resin melt bonded to at least one resin sheet having irregular surfaces.

2. The process as recited in claim 1 wherein said sheet having irregular surfaces is a fabric or a microporous sheet.

3. The process as recited in claim 1 wherein said barrier layer resin and said resin sheet having irregular surfaces are melt bonded together before being attached to said pipe or container.

4. The process as recited in claim 1 wherein said resin sheet having irregular surfaces is melt bonded to said container before said barrier layer resin is melt bonded to said sheet having irregular surfaces.

5. The process as recited in claim 1 wherein said resin sheet having irregular surfaces is melt bonded to said pipe or container essentially simultaneously with the melt bonding of said barrier layer to said resin sheet having irregular surfaces.

6. The process as recited in claim 1 wherein said pipe is wrapped helically with said resin sheet having irregular surfaces and said barrier layer resin.

7. The process as recited in claim 6 wherein said wrapped layers of said barrier resin and/or resin sheet having irregular surfaces overlap

8. The process as recited in claim 7 wherein said resin sheet having irregular surfaces contacts the exterior of said pipe said barrier layer resin is wider than said irregularly surfaced sheet on one edge and wherein said pipe is wrapped such that said edge overlaps a portion of said barrier layer resin previously applied while wrapping.

9. The process as recited in claim 1 wherein a shrink wrap layer is applied to said pipe or container overlaid with said multilayer structure to aid melt bonding.

10. The process as recited in claim 1 wherein said pipe or container's surface is at least 90% covered by said barrier layer resin.

11. The process as recited in claim 1 wherein said barrier resin is a liquid crystalline polymer.

12. The process as recited in claim 1 wherein said pipe or container is made of polyethylene.

13. The product of the process of claim 1.

14. The product of the process of claim 2.

15. The product of the process of claim 3.

16. The product of the process of claim 6.

17. The product as recited in claim 13 wherein said container or pipe is used to store and/or transport fuels, natural gas, or water.
